(19) United States
(12) Patent Application Publication
(10) Pub. No.: US 2023/0258780 A1
(43) Pub. Date: Aug. 17, 2023

(54) LIGHT DETECTION DEVICE

(71) Applicant: DENSO CORPORATION, Kariya-city (JP)

(72) Inventors: KAZUHISA ONDA, Kariya-city (JP); SAKITO MIKI, Kariya-city (JP); MITSUHIRO KIYONO, Kariya-city (JP)

(21) Appl. No.: 18/308,578

(22) Filed: Apr. 27, 2023

Related U.S. Application Data
(63) Continuation of application No. PCT/JP2021/038589, filed on Oct. 19, 2021.

(30) Foreign Application Priority Data
Nov. 3, 2020 (JP) 2020-184033

(51) Int. Cl. G01S 7/481; G01S 17/931; G02B 26/10; G02B 27/09

(52) U.S. Cl. CPC G01S 7/4817; G01S 7/4815; G01S 17/931; G02B 26/105; G02B 27/0961; G02B 27/0966; G02B 27/0988; G02B 27/0927

(57) ABSTRACT

A LiDAR device is an optical device, including a light-emitting unit, a scanning unit, a light-receiving unit, and an optical unit. The light-emitting unit includes a plurality of laser oscillation elements respectively emitting a beam in an arrangement along a light source array direction at intervals from each other. The scanning unit projects the beam to a measurement area by scanning of the beam that is emitted from the light-emitting unit. The light-receiving unit receives a reflected beam from the measurement area. The optical unit is positioned on an optical path of the beam directed from the light-emitting unit to the scanning unit. The optical unit includes a collimator lens having a positive power in a transmission direction of the beam, and a beam shaping lens positioned behind the collimator lens and having a positive power in the transmission direction on a sub-scanning plane.

### CROSS REFERENCE TO RELATED APPLICATION

The present application is a continuation application of International Patent Application No. PCT/JP2021/038589 filed on Oct. 19, 2021, which designated the U.S. and claims the benefit of priority from Japanese Patent Application No. 2020-184033 filed on Nov. 3, 2020. The entire disclosures of all of the above applications are incorporated herein by reference.

### TECHNICAL FIELD

The disclosure according to this specification relates to a light detection device.

### BACKGROUND

Conventionally, a distance measuring device includes a rotary deflecting mirror that reflects laser light emitted from a light source to measure a distance from an object.

### SUMMARY

According to an aspect of the present disclosure, a light detection device includes:

a light-emitting unit including a plurality of light emitters spaced from each other, arranged along a specific array direction, and configured to emit a beam;

a scanning unit configured to scan the beam emitted from the light-emitting unit to project the beam to a measurement area;

a light-receiving unit configured to receive a return light of the beam from the measurement area; and

an optical unit positioned on an optical path of the beam directed from the light-emitting unit to the scanning unit.

### BRIEF DESCRIPTION OF THE DRAWINGS

Objects, features, and advantages of the present disclosure will become more apparent from the following detailed description made with reference to the accompanying drawings, in which:

FIG. 1 is a diagram illustrating a configuration of a LiDAR device according to a first embodiment of the present disclosure;

FIG. 2 is a diagram for explaining an optical action of an optical unit on a sub-scanning plane;

FIG. 3 is a diagram for explaining the optical action of the optical unit on a main scanning plane;

FIG. 4 is a diagram for explaining a structure of the optical unit on the sub-scanning plane;

FIG. 5 is a diagram for explaining a structure of the optical unit on the main scanning plane;

FIG. 6 is a diagram for explaining the optical action on the sub-scanning plane of the optical unit in a comparative example;

FIG. 7 is a diagram illustrating the optical action on the sub-scanning plane of the optical unit according to a second embodiment of the present disclosure;

FIG. 8 is a diagram for explaining the optical action on the sub-scanning plane of the optical unit according to a third embodiment of the present disclosure;

FIG. 9 is a diagram for explaining the optical action on the sub-scanning plane of the optical unit according to a fourth embodiment of the present disclosure;

FIG. 10 is a diagram for explaining the optical action on the sub-scanning plane of the optical unit according to a fifth embodiment of the present disclosure;

FIG. 11 is a diagram for explaining the optical action on the main scanning plane of the optical unit according to the fifth embodiment of the present disclosure;

FIG. 12 is a diagram for explaining the optical action on the sub-scanning plane of the optical unit according to a sixth embodiment of the present disclosure;

FIG. 13 is a diagram for explaining the optical action on the sub-scanning plane of the optical unit according to a seventh embodiment of the present disclosure;

FIG. 14 is a diagram for explaining the optical action on the main scanning plane of the optical unit according to the seventh embodiment of the present disclosure;

FIG. 15 is a diagram for explaining the optical action on the sub-scanning plane of the optical unit according to an eighth embodiment of the present disclosure;

FIG. 16 is a diagram for explaining the optical action on the main scanning plane of the optical unit according to the eighth embodiment of the present disclosure; and

FIG. 17 is a diagram for explaining the optical action on the sub-scanning plane of the optical unit according to Modification 1.

### DETAILED DESCRIPTION

Hereinafter, examples of the present disclosure will be described.

According to an example of the present disclosure, a distance measuring device scans an irradiated area outside the device by reflecting laser lights emitted as a plurality of one-dimensionally arranged edge-emitting lasers or surface-emitting lasers by a rotary deflecting mirror. This distance measuring device measures the distance to an object existing in the irradiated area by receiving the reflected light of the laser light irradiated to the irradiated area.

In a structure in which a plurality of light emitters such as edge-emitting lasers or surface-emitting lasers are arranged, each of the positions between the plurality of light emitters, acting as a no-emitter, is inevitably made. In a case where such a no-emitter exists, no-emitting areas occur as positions between the laser lights to be irradiated to the irradiated area. Further, in the non-emitting area not emitting the laser light, a target object is not detectable, which may cause a no-detection area. As a result, a reduction in detection resolution could occur.

According to an example of the present disclosure, a light detection device includes:

a light-emitting unit including a plurality of light emitters spaced from each other, arranged along a specific array direction, and configured to emit a beam;

a scanning unit configured to scan the beam emitted from the light-emitting unit to project the beam to a measurement area;

a light-receiving unit configured to receive a return light of the beam from the measurement area; and

an optical unit positioned on an optical path of the beam directed from the light-emitting unit to the scanning unit.

The optical unit includes:

a first optical element having a positive power in a transmission direction of the beam directed from the light-emitting unit to the scanning unit; and

a second optical element positioned behind the first optical element and having a positive power in the transmission direction of the beam in a specific section that expands along both of the transmission direction and the specific array direction.

According to another example of the present disclosure, a light detection device includes:

a light-emitting unit including a plurality of light emitters spaced from each other, arranged along a specific array direction, and configured to emit a beam;

a scanning unit configured to scan the beam emitted from the light-emitting unit to project the beam to a measurement area;

a light-receiving unit receiving a return light of the beam from the measurement area; and

an optical unit positioned on an optical path of the beam directed from the light-emitting unit to the scanning unit.

The optical unit includes:

a first optical element having a positive power in a transmission direction of the beam directed from the light-emitting unit to the scanning unit; and

a second optical element behind the first optical element to generate a diffracted light in a specific section that expands along both of the transmission direction and the specific array direction.

In these examples, a transmission direction of the beam emitted from each of the plurality of light emitters arranged along the specific array direction is adjusted by the first optical element, and then, due to the positive power or generation of the diffracted light of the second optical element, is spread along the specific array direction on the specific section. Therefore, even when there is a no-emitter between the plurality of light emitters in the light-emitting unit, a gap that causes a no-detection area to occur between the beams projected to the measurement area hardly occurs. Therefore, it is possible to increase the resolution of detection of the light detection device.

According to another example of the present disclosure, a light detection device includes:

a light-emitting unit including a plurality of light emitters spaced from each other, arranged along a specific array direction, and configured to emit a beam;

a scanning unit configured to scan the beam emitted from the light-emitting unit to project the beam to a measurement area;

a light-receiving unit configured to receive a return light of the beam from the measurement area; and

an optical unit positioned on an optical path of the beam directed from the light-emitting unit to the scanning unit.

The optical unit includes:

a first optical element having a first cylindrical lens surface that has a positive power in a transmission direction of the beam directed from the light-emitting unit to the scanning unit, the first optical element arranged, such that a generatrix direction of the first cylindrical lens surface is along the specific array direction; and

a second optical element positioned behind the first optical element and having a second cylindrical lens surface that has a positive power or a negative power in the transmission direction, the second optical element arranged, such that an orthogonal direction of a generatrix of the second cylindrical lens surface is along the specific array direction.

In this example, the travel direction of the beam emitted from each of the plurality of light emitters that are arranged along the specific array direction is adjusted by the first cylindrical lens surface, and the travel direction is then spread along the specific array direction, due to the positive or the negative power of the second cylindrical lens surface. Therefore, even when there is a no-emitter between the plurality of light emitters in the light-emitting unit, a gap that causes a no-detection area to occur between the beams projected to the measurement area hardly occurs. Therefore, it is possible to increase the resolution of detection of the light detection device.

According to another example of the present disclosure, a light detection device includes:

a light-emitting unit including a plurality of light emitters spaced from each other, arranged along a specific array direction, and configured to emit a beam;

a scanning unit configured to scan the beam emitted from the light-emitting unit to project the beam to a measurement area;

a light-receiving unit configured to receive a return light of the beam from the measurement area; and

an optical unit positioned on an optical path of the beam directed from the light-emitting unit to the scanning unit.

The optical unit includes:

a homogenizer configured to homogenize an intensity of beam emitted from each of the plurality of the light emitters at least along the specific array direction; and

a shaping optical element positioned behind the homogenizer and configured to shape the beam, which is imaged by the homogenizer, in a line shape extending along the specific array direction.

In this example, the beam emitted from each of the plurality of light emitters arranged along the specific array direction has its intensity homogenized along the specific array direction by the homogenizer, and the beam is shaped by the shaping optical element to have the line shape extending along the specific array direction. Therefore, even when there is a no-emitter between the plurality of light emitters in the light-emitting unit, a gap that causes a no-detection area to occur between the beams projected to the measurement area hardly occurs. Therefore, it is possible to increase the resolution of detection of the light detection device.

Hereinafter, embodiments of the present disclosure are described with reference to the drawings. In the following description, the same reference symbols are assigned to corresponding components in each of the embodiments in order to avoid repetitive description. In each of the embodiments, when only a part of the configuration is described, the remaining part of the configuration may adopt corresponding parts of other embodiment(s). In addition to the combinations of configurations specifically shown in various embodiments, the configurations of various embodiments are partly combinable even when not explicitly suggested, unless such combinations are contradictory. Moreover, combinations of configurations mentioned in the embodiments and modifications which are not explicitly disclosed are assumed to be encompassed in following description.

### First Embodiment

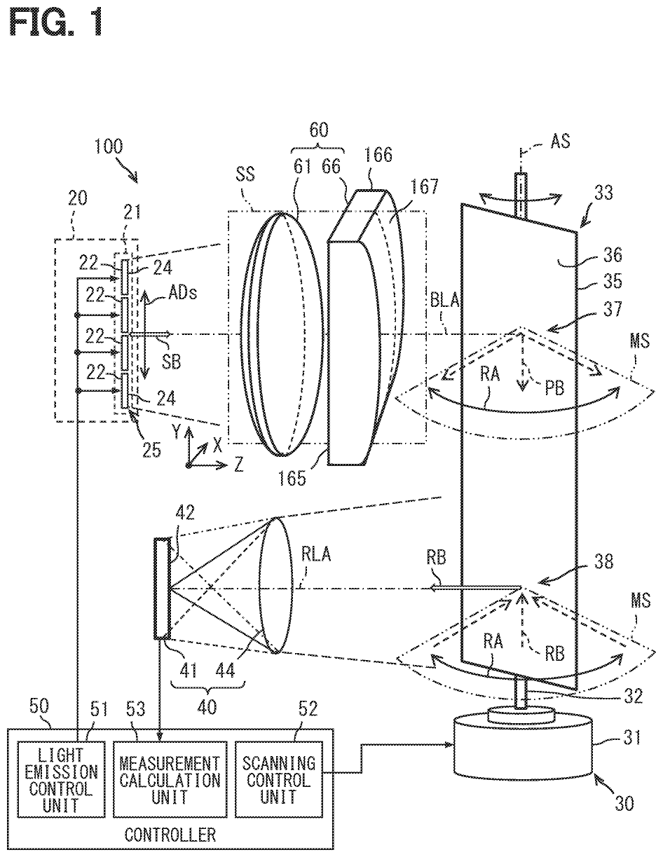

A LiDAR device 100, or Light Detection and Ranging/Laser Imaging Detection and Ranging device 100, according to the first embodiment of the present disclosure shown in FIGS. 1 to 3 functions as a light detection device. The LiDAR device 100 is mounted on a vehicle which is a mobile object. The LiDAR device 100 is arranged, for example, in a front portion, left and right side portions, a rear portion, or on a roof of the vehicle. The LiDAR device 100 scans a predetermined field area (hereinafter referred to as a measurement area) near the vehicle outside the device with a projection beam PB. The LiDAR device 100 detects a return light (hereinafter referred to as a reflected beam RB) resulting from reflection of the projection beam PB irradiated to the measurement area and reflected by a measurement object. A near-infrared light, which is difficult for humans in the field outside the device 100 to visually recognize, is normally used as the projection beam PB.

The LiDAR device 100 can measure the measurement object by detecting the reflected beam RB. The measurement of the measurement object includes, for example, measurement of a direction (i.e., a relative direction) in which the measurement object exists, measurement of a distance (i.e., relative distance) from the LiDAR device 100 to the measurement object, and the like. Typical objects to be measured by the LiDAR device 100 applied to a vehicle include moving objects such as pedestrians, cyclists, non-human animals, and other vehicles, as well as structures such guardrails (i.e., railings on roadside), road signs, roadside structures and buildings, a stationary object such as a fallen object and the like.

Unless otherwise specified, the front, rear, up, down, left and right directions are defined with reference to a vehicle standing still on a horizontal plane. Also, the horizontal direction indicates a tangential direction tangential to the horizontal plane, and the vertical direction indicates a vertical direction orthogonal to the horizontal plane.

The LiDAR device 100 includes a light-emitting unit 20, a scanning unit 30, a light-receiving unit 40, a controller 50, an optical unit 60, and a housing that accommodates these components.

The housing forms an outer shell of the LiDAR device 100. The housing is composed of a light-shielding container, a cover panel, and the like. The light-shielding container is made of a light-shielding synthetic resin, metal, or the like, and has a substantially rectangular parallelepiped box shape as a whole. An accommodation chamber and an optical window are formed in the light-shielding container. The accommodation chamber accommodates main optical components of the LiDAR device 100. The optical window is a rectangular opening that allows both the projection beam PB and the reflected beam RB to travel back and forth between the accommodation chamber and the measurement area. The cover panel is a lid made of translucent material such as synthetic resin, glass or the like. The cover panel is formed with a transmitting portion that transmits the projection beam PB and the reflected beam RB. The cover panel is attached to the light-shielding container in such a manner that the transmitting portion covers the optical window of the light-shielding container. The housing is held by the vehicle with the longitudinal direction of the optical window aligned with the horizontal direction of the vehicle.

The light-emitting unit 20 has a plurality of laser oscillation elements 22. Each of the laser oscillation element 22 is electrically connected to the controller 50. Each of the laser oscillation elements 22 emits a beam SB from a laser emission window 24 at an emission timing according to an electrical signal from the controller 50.

A laser diode is adopted for each of the laser oscillation elements 22. Each of the laser oscillation elements 22 has a resonator structure. The resonator structure includes an active layer joined between a P-type semiconductor and an N-type semiconductor, and a pair of mirrors arranged on both end faces of the active layer. In the resonator structure, electrons and holes are supplied to the active layer by applying a voltage to each of the semiconductors. Electrons and holes emit light by recombination within the active layer. Light generated in the active layer is amplified by stimulated emission, and is repeatedly reflected by the pair of mirrors arranged to sandwich the active layer, thereby forming coherent laser light with the same phase. The resonator structure emits in-phase laser light through a half-mirror-like laser emission window 24 provided on one of the mirrors. This beam-shaped laser light (hereinafter referred to as a beam SB) forms a part of the projection beam PB. That is, an aggregation of the beams SB oscillated from the plurality of laser oscillation elements 22 becomes the projection beam PB.

As an example of the laser oscillation element 22 described above, an edge-emitter type element that emits the beam SB from the side surface of the resonator structure is adopted. A Vertical Cavity Surface Emitting Laser (VCSEL) having a cavity structure orthogonal to a semiconductor substrate may also be adopted as the laser oscillation element 22. The VCSEL emits a beam SB orthogonally to the semiconductor substrate.

The plurality of laser oscillation elements 22 are arranged on a main substrate of the light-emitting unit 20 in a long rectangular light-emitting area 21 elongated in a longitudinal direction that is in a specific light source array direction ADs. The light-emitting area 21 is an area on the main substrate where the laser oscillation element 22 is mounted. The light-emitting area 21 may be (i) a planar area along a Z-X plane (described later) (ii) a planar area along an X-Y plane (described later), or a spatial area in three dimensions as long as it has a longitudinal shape elongated in the longitudinal direction that is in the light source array direction ADs. The shape of the light-emitting area 21 may be, for example, an elliptical shape or the like. The plurality of laser oscillation elements 22 are spaced from each other and arranged in the light-emitting area 21 at intervals along the light source array direction ADs. The plurality of laser oscillation elements 22 may be arranged in a single row (one row) or in multiple rows.

Each of the laser oscillation elements 22 has, formed thereon, the above-described laser emission window 24 in a rectangular shape. Each of the laser oscillation elements 22 is mounted on the main substrate with the longitudinal direction of the laser emission window 24 along the light source array direction ADs. By arranging the plurality of laser emission windows 24 in a row, a narrow band-shaped laser emission opening 25 extending in the light source array direction ADs is formed in the light emitting area 21. The normal at the center of the laser emission opening 25 is the optical axis of the beam SB emitted from the laser emission opening 25 (i.e., a beam light axis BLA, in the following description). Also, the dimension of the laser emission opening 25 in the light source array direction ADs is, for example, 100 times or more of the dimension in the width direction orthogonal to the light source array direction ADs.

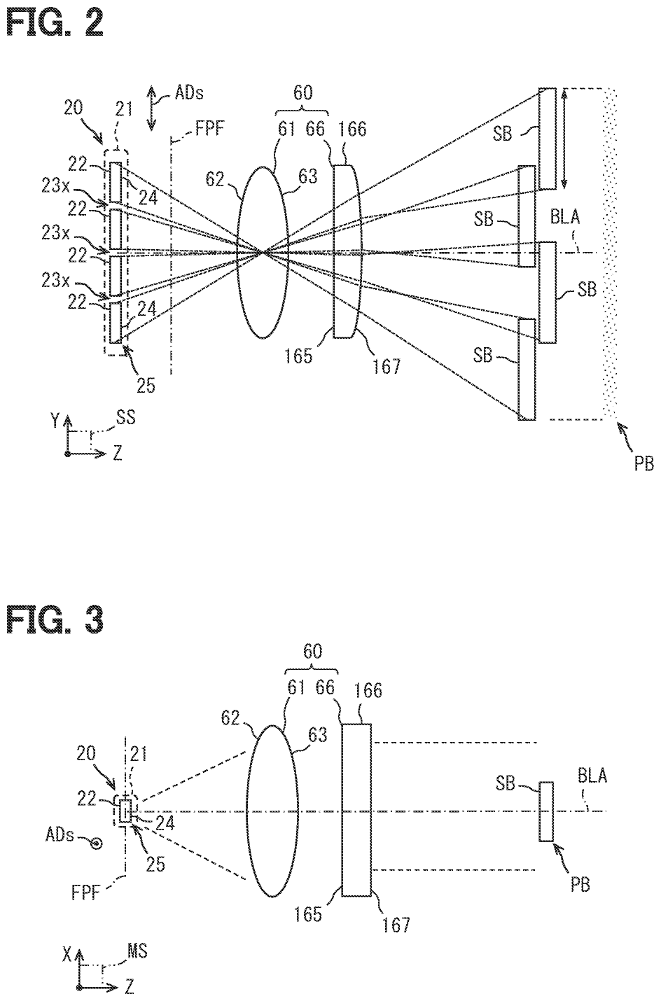

Instead of forming the laser emission opening 25 as a plurality of laser emission windows 24, a light source structure in which a narrow belt-like laser emission window is formed in one laser oscillation element may be assumable. However, such a light source structure causes a decrease in luminous efficiency, making it difficult to ensure the output of the beam SB. On the other hand, the above configuration in which a plurality of laser oscillation elements 22 are arranged in an array shape is suitable for forming a pseudo extending laser emission opening 25 while ensuring the overall output of the beam SB. Note that, however, a predetermined gap is reserved between the plurality of laser oscillation elements 22 in order to ensure, for example, cooling performance, manufacturability, luminous efficiency and the like. As a result, no-emitters 23x caused by the gap between the laser oscillation elements 22 is inevitably generated in the laser emission opening 25 (see FIG. 2).

The scanning unit 30 performs scanning with the beam SB emitted from each of the laser oscillation elements 22, by projecting the beam SB as a projection beam PB to the measurement area. In addition, the scanning unit 30 causes the reflected beam RB reflected by the measurement area to enter the light-receiving unit 40. The scanning unit 30 includes a drive motor 31, a scanning mirror 33, and the like.

The drive motor 31 is, for example, a voice coil motor, a brushed DC motor, a stepping motor, or the like. The drive motor 31 has a shaft portion 32 mechanically coupled to the scanning mirror 33. The shaft portion 32 is arranged along the light source array direction ADs of the laser oscillation element 22, and defines a rotation axis AS of the scanning mirror 33. The rotation axis AS is disposed in a posture aligned with the light source array direction ADs, and is substantially in parallel with the light source array direction ADs. The drive motor 31 drives the shaft portion 32 at a rotation amount and a rotation speed according to the electric signal from the controller 50.

The scanning mirror 33 reciprocally rotates about the rotation axis AS defined by the shaft portion 32, thereby swinging in a finite angular range RA. The angular range RA of the scanning mirror 33 can be set by a mechanical stopper, an electromagnetic stopper, drive control, or the like. The angular range RA is limited so that the projection beam PB does not leave the optical window of the housing.

The scanning mirror 33 has a body portion 35 and a reflecting surface 36. The body portion 35 is formed in a flat plate shape, for example, made of glass, synthetic resin, or the like. The body portion 35 is coupled to the shaft portion 32 of the drive motor 31 using a mechanical component made of metal or the like. The reflecting surface 36 is a mirror surface obtained by performing vapor deposition of a metal film such as aluminum, silver or gold on one surface of the body portion 35 and further forming a protective film such as silicon dioxide on the vapor-deposited surface. The reflecting surface 36 is formed in a smooth rectangular planar shape. The reflecting surface 36 is provided in a posture in which the longitudinal direction is along the rotation axis AS. As a result, the longitudinal direction of the reflecting surface 36 substantially matches the light source array direction ADs.

The scanning mirror 33 is provided to accommodate both of the projection beam PB and the reflected beam RB. That is, the scanning mirror 33 serves a part of the reflecting surface 36 as a projecting reflector 37 used for projecting the projection beam PB, and serves another part of the reflecting surface 36 as a receiving reflector 38 used for receiving the reflected beam RB. The projecting reflector 37 and the receiving reflector 38 may be defined as areas separated from each other on the reflecting surface 36, or may be defined as areas at least partially overlapping each other.

The scanning mirror 33 changes a deflection direction of the projection beam PB according to the change in the orientation of the reflecting surface 36. The scanning mirror 33 chronologically and spatially scans the measurement area by moving the projection beam PB irradiated toward the measurement area according to the rotation of the drive motor 31. Such scanning by the scanning mirror 33 is scanning only about the rotation axis AS, and is one-dimensional scanning in which scanning in the light source array direction ADs is omitted.

With the configuration described above, a main scanning plane MS of the scanning mirror 33 is a plane that is substantially orthogonal to the rotation axis AS. On the other hand, a plane expanding along (i.e., substantially parallel with) both of (i) the beam light axis BLA of the beam SB entering the scanning unit 30 from the light-emitting unit 20 and (ii) the rotation axis AS is a sub-scanning plane SS of the scanning mirror 33. The main scanning plane MS and the sub-scanning plane SS are planes orthogonal to each other. The light source array direction ADs is a direction substantially parallel with the sub-scanning plane SS and is a direction substantially orthogonal to the main scanning plane MS. The scanning by using the scanning mirror 33 is performed as a scan of the irradiation range of the projection beam PB extending in a line shape along the light source array direction ADs, which reciprocates along the main scanning plane MS.

Here, when the LiDAR device 100 is mounted on a vehicle, the light source array direction ADs, the rotation axis AS, and the sub-scanning plane SS are respectively aligned with the vertical direction. On the other hand, the beam light axis BLA and the main scanning plane MS are respectively aligned with the horizontal direction. As described above, the shape of the projection beam PB irradiated to the measurement area becomes a line shape extending in the vertical direction, thereby defining the vertical angle of view of the LiDAR device 100. On the other hand, the finite angular range RA in scanning by the scanning mirror 33 defines the horizontal angle of view of the LiDAR device 100 because it defines the irradiation range of the projection beam PB.

The light-receiving unit 40 receives the reflected beam RB from the measurement area, which is a return light of the projection beam PB projected thereto. The reflected beam RB is a laser light that is incident on the scanning mirror 33 after the projection beam PB that has passed through the optical window of the housing is reflected by the measurement object that exists in the measurement area, passes through the optical window again, and is incident on the scanning mirror 33. Since the speed of the projection beam PB and the reflected beam RB are sufficiently high with respect to the rotation speed of the scanning mirror 33, the phase shift between the projection beam PB and the reflected beam RB is negligible. Therefore, the reflected beam RB is reflected by the reflecting surface 36 at substantially the same angle of reflection as the projection beam PB, and is guided to the light-receiving unit 40 in a direction opposite to that of the projection beam PB.

The light-receiving unit 40 includes a detector 41, a light-receiving lens 44, and the like. The detector 41 is provided with a detection surface 42 and a decoder. The detection surface 42 is formed by a large number of light-receiving elements. A large number of light-receiving elements are arranged to have an array shape in a highly-integrated state, and form a long rectangular element array on the detection surface 42. The longitudinal direction of the detection surface 42 is along the light source array direction ADs, which is the longitudinal direction of the laser emission opening 25, and is substantially in parallel with the light source array direction ADs. With the configuration described above, the detection surface 42 can efficiently receive the reflected beam RB in a line shape extending along the light source array direction ADs.

As an example of the light-receiving element, a single photon avalanche diode (SPAD) is adopted. When one or more photons are incident on the SPAD, the electron doubling action due to avalanche doubling produces an electric pulse. The SPAD can output an electric pulse, which is a digital signal, without going through an AD conversion circuit. As a result, high-speed readout of the detection result of the reflected beam RB condensed on the detection surface 42 is realized. Note that an element different from the SPAD can also be adopted as the light-receiving element. For example, a normal avalanche photodiode, other photodiodes, etc. can be adopted as the light-receiving element.

The decoder is an electric circuit unit that outputs an electric pulse generated by the light-receiving element to the outside. The decoder sequentially selects a target element from which electric pulses are extracted from among a large number of light-receiving elements. The decoder outputs the electric pulse of the selected light-receiving element to the controller 50. When the outputs from all the light-receiving elements are complete, one sampling is complete.

The light-receiving lens 44 is an optical element positioned on an optical path of the reflected beam RB from the scanning mirror 33 toward the detector 41. The light-receiving lens 44 forms a light-receiving optical axis RLA. The light-receiving optical axis RLA is defined as an axis aligned with a virtual ray passing through the center of curvature of each of the refractive surfaces of the light-receiving lens 44. The light-receiving optical axis RLA is substantially in parallel with the beam light axis BLA. The light-receiving lens 44 condenses and focuses the reflected beam RB to the detection surface 42. The light-receiving lens 44 condenses the reflected beam RB reflected by the reflecting surface 36 to the detection surface 42 regardless of the orientation of the scanning mirror 33.

The controller 50 controls the light detection of the measurement area. The controller 50 includes (i) a control circuit section including a processor, a RAM, a storage section, an input/output interface, and a bus connecting them, and (ii) a drive circuit section for driving the laser oscillation element 22 and the drive motor 31. The control circuit section is mainly composed of a microcontroller including, for example, a CPU (Central Processing Unit) as a processor. The control circuit section may be configured mainly as an FPGA (Field-Programmable Gate Array), an ASIC (Application Specific Integrated Circuit) or the like.

The controller 50 is electrically connected to each of the laser oscillation elements 22, the drive motor 31 and the detector 41. The controller 50 includes functional units such as a light emission control unit 51, a scanning control unit 52, a measurement computation unit 53, and the like. Each of the functional units may be constructed as a software component based on a program, or may be constructed as a hardware component.

The light emission control unit 51 outputs a drive signal to each of the laser oscillation elements 22 so that the beam SB is emitted from each of the laser oscillation elements 22 at a light emission timing coordinated with the beam scanning by the scanning mirror 33. The light emission control unit 51 causes each of the laser oscillation elements 22 to oscillate the beam SB in the form of a short pulse. The light emission control unit 51 may control the oscillation of the beam SB by the plurality of laser oscillation elements 22 to substantially synchronize, or may control each of the laser oscillation elements 22 to sequentially oscillate with a slight time difference one after another.

The scanning control unit 52 outputs a drive signal to the drive motor 31 to realize beam scanning in cooperation with beam oscillation by the laser oscillation element 22.

The measurement computation unit 53 performs computation processing on the electric pulse input from the detector 41, and determines the presence or absence of the measurement object in the measurement area. In addition, the measurement computation unit 53 measures the distance to the measurement object whose existence is grasped. In each sampling, the measurement computation unit 53 counts the number of electric pulses output from each of the light-receiving elements of the detector 41 after the projection beam PB is projected. The measurement computation unit 53 generates a histogram recording the number of electric pulses for each sampling. The class of the histogram indicates a time of flight (TOF) of light from an emission time of the beam SB to the detection time of the reflected beam RB. The sampling frequency of the detector 41 corresponds to the time resolution in TOF measurement.

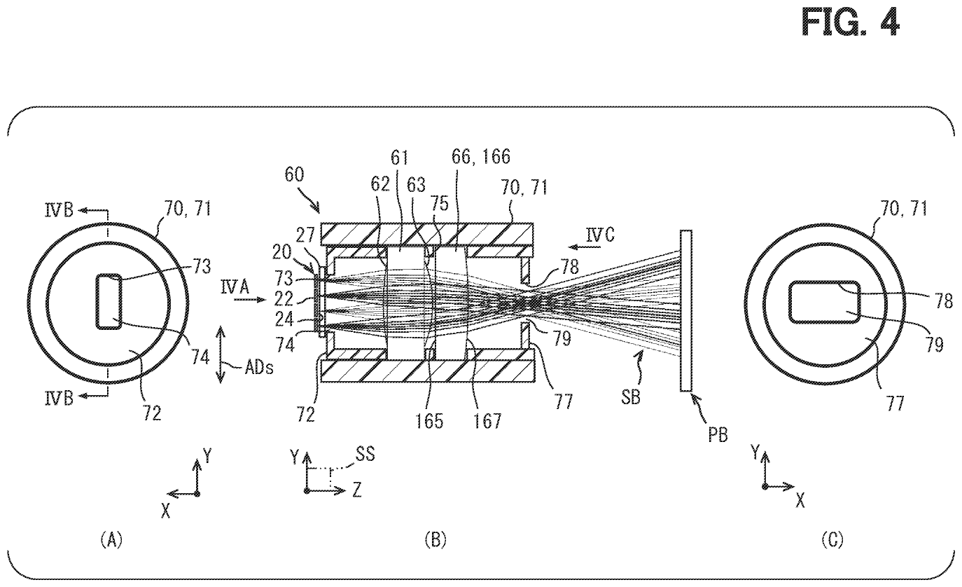

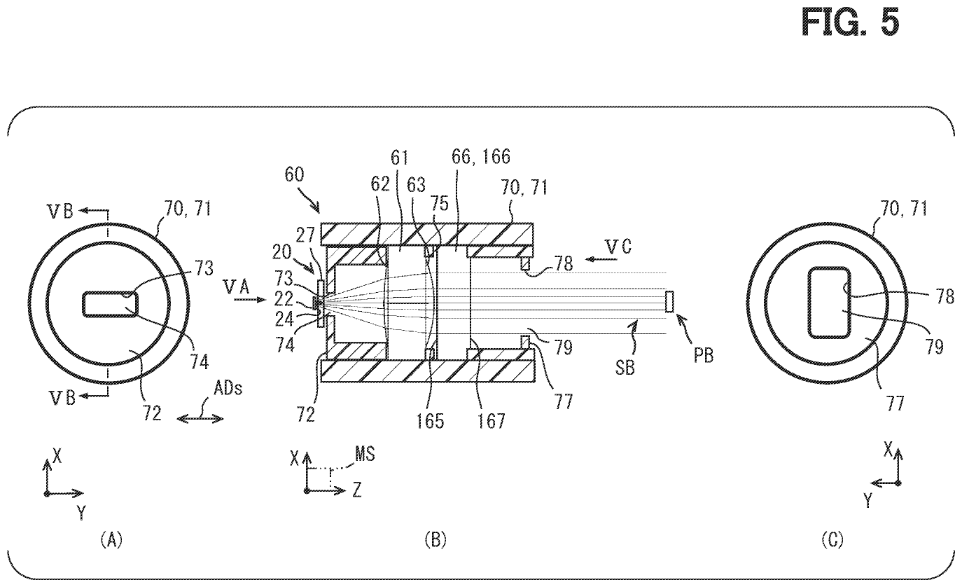

The optical unit 60 includes a group of optical elements positioned on the optical path of the beam SB from the light-emitting unit 20 to the scanning unit 30. The optical unit 60 adjusts the shape of a group of the beams SB emitted from each of the laser oscillation elements 22, and makes the shaped group of beams SB incident on the reflecting surface 36. The optical unit 60 includes a collimator lens 61, a beam shaping lens 66, a lens barrel 70 (see FIGS. 4 and 5), and the like.

Here, in order to describe the detailed configuration of the optical unit 60, the X-axis, Y-axis and Z-axis are defined. The X-axis is substantially orthogonal to the sub-scanning plane SS of the scanning unit 30, and is substantially in parallel with the main scanning plane MS of the scanning unit 30. The X-axis corresponds to a fast axis of laser light. The Y-axis is substantially in parallel with the light source array direction ADs and with the rotation axis AS. The Y-axis corresponds to a slow axis of laser light. The Z-axis is substantially in parallel with the beam light axis BLA from the light-emitting area 21 toward the scanning mirror 33. The Z direction is the transmission direction of the beam SB passing through the optical unit 60, and is a direction from the light-emitting unit 20 to the scanning unit 30. As described above, a Z-X plane of the optical unit 60 coincides with the main scanning plane MS of the LiDAR device 100 (see FIG. 3). Also, a Y-Z plane of the optical unit 60 coincides with the sub-scanning plane SS of the LiDAR device 100 (see FIG. 2).

The collimator lens 61 is made of translucent material having excellent optical properties, such as synthetic quartz glass, synthetic resin or the like. The collimator lens 61 employs an aspheric biconvex lens. The collimator lens 61 has (i) a convex incident surface 62 that is convex on one side, i.e., on a side facing the light-emitting unit 20, and (ii) a convex emission surface 63 that is convex on the other side facing the scanning unit 30. The collimator lens 61 is arranged on the optical path of the beam SB so that the beam light axis BLA passes through the optical centers of the convex incident surface 62 and the convex emission surface 63. The normal to each of the optical centers of the convex incident surface 62 and the convex emission surface 63, that is, a lens optical axis of the collimator lens 61 substantially coincides with the beam light axis BLA.

The collimator lens 61 has a positive power in the transmission direction (i.e., Z direction) of the beam SB from the light-emitting unit 20 toward the scanning unit 30. The collimator lens 61 generates a parallel light aligned along the beam light axis BLA at least on the main scanning plane MS, by condensing the traveling directions of the beam SB on the beam light axis BLA with the refractive optical action of the beam SB by the convex incident surface 62 and the convex emission surface 63. The collimator lens 61 is positioned before the beam shaping lens 66, and causes the beam SB in parallel with the beam light axis BLA to enter the beam shaping lens 66.

The beam shaping lens 66 is positioned behind the collimator lens 61. The beam shaping lens 66 has a positive power in the transmission direction (i.e., Z direction) on the sub-scanning plane SS expanding in the transmission direction of the beam SB and the light source array direction ADs. A cylindrical lens 166 is adopted as the beam shaping lens 66.

Similarly to the collimator lens 61, the cylindrical lens 166 is made of translucent material such as synthetic quartz glass, synthetic resin or the like. The cylindrical lens 166 is an optical element having an astigmatic optical action. The cylindrical lens 166 has a planar incident surface 165 and a cylindrical emission surface 167. The planar incident surface 165 is a smooth plane, and substantially orthogonal to the beam light axis BLA. The cylindrical emission surface 167 is a spherical, partially-cylindrical surface or an aspherical, partially-cylindrical surface, and is convexly curved in the Z direction, which is a convex toward an emission side on the sub-scanning plane SS.

The cylindrical lens 166 is arranged in such a posture that the lens cross section having a positive power is in parallel with the sub-scanning plane SS. The position of the cylindrical lens 166 along the X-Y plane is adjusted so that the optical center of the cylindrical emission surface 167 is set on the beam light axis BLA. The cylindrical lens 166 substantially spreads the beam SB only in one direction on the sub-scanning plane SS by the optical action of the planar incident surface 165 and the cylindrical emission surface 167 that refract the beam SB (see FIG. 2). On the other hand, the cylindrical lens 166 does not substantially exhibit the optical action of deflecting the beam SB on the main scanning plane MS (see FIG. 3).

The lens barrel 70 shown in FIGS. 4 and 5 is formed in a cylindrical shape as a whole with light-shielding synthetic resin, metal, or the like. The lens barrel 70 accommodates the collimator lens 61 and the cylindrical lens 166. A cover glass 27 is attached to the lens barrel 70. The cover glass 27 is a member that protects the laser oscillation element 22. The cover glass 27 may be included in the light-emitting unit 20, or may be included in the optical unit 60. The lens barrel 70 defines a positional relationship among the laser oscillation elements 22, the collimator lens 61 and the beam shaping lens 66 with high accuracy. The lens barrel 70 is held by a structure such as a housing. In such manner, the positional relationship among the collimator lens 61, the cylindrical lens 166 and the reflecting surface 36 is defined.

The lens barrel 70 includes a cylindrical main body 71, an incident-side member 72, an intermediate member 75 and an emission-side member 77. The cylindrical main body 71 is formed in a cylindrical shape. The cylindrical main body 71 holds the incident-side member 72, the intermediate member 75, and the emission-side member 77 by an inner peripheral wall surface.

The incident-side member 72 is formed in a cylindrical shape with a bottom. The incident-side member 72 is fitted into the inner peripheral wall surface of the cylindrical main body 71 with a bottom wall facing the light-emitting unit 20. The incident-side member 72 is positioned on one side of the collimator lens 61 on the side of the light-emitting unit 20, and regulates movement of the collimator lens 61 toward the light-emitting unit 20. Afield throttle 73 is formed on the bottom wall of the incident-side member 72.

The field throttle 73 defines an incident-side opening 74 at the center of the bottom wall of the incident-side member 72. The incident-side opening 74 is formed in a substantially rectangular shape elongated in a longitudinal direction that is the light source array direction ADs. The incident-side opening 74 is provided near a composite focal plane FPF of the optical unit 60 on the main scanning plane MS. The light-emitting unit 20 attached to the bottom wall of the incident-side member 72 causes the beam SB emitted from each of the laser emission windows 24 to enter the lens barrel 70 through the incident-side opening 74. The field throttle 73 is positioned before the collimator lens 61, i.e., on an incident side of the collimator lens 61, and adjusts (i.e., limits) the angle of the beam SB emitted from the laser emission window 24.

The intermediate member 75 has an annular shape, and is arranged at a position between the collimator lens 61 and the cylindrical lens 166. The intermediate member 75 regulates the movement of the collimator lens 61 toward the scanning unit 30, and regulates the movement of the cylindrical lens 166 toward the light-emitting unit 20.

The emission-side member 77 is formed in a cylindrical shape with a bottom. The emission-side member 77 is fitted into the inner peripheral wall surface of the cylindrical main body 71 with a bottom wall facing the scanning unit 30. The emission-side member 77 is positioned on one side of the cylindrical lens 166 on the side of the scanning unit 30, and regulates the movement of the cylindrical lens 166 toward the scanning unit 30. An opening throttle 78 is formed on the bottom wall of the emission-side member 77.

The opening throttle 78 defines an emission-side opening 79 at the center of the bottom wall of the emission-side member 77. The emission-side opening 79 is formed in a substantially rectangular shape elongated in a longitudinal direction that is a direction along the X-axis. The emission-side opening 79 is provided at a position where the beam SB condenses most on the sub-scanning plane SS. The emission-side opening 79 emits the beam SB transmitted through the cylindrical lens 166 toward the scanning unit 30. The opening throttle 78 is positioned behind the cylindrical lens 166 on the emission side, and uniformly adjusts the light amount of the beam SB emitted to the scanning unit 30 regardless of the emission angle of the beam SB.

Next, the details of the optical effects of the configuration in which the cylindrical lens 166 is added behind the collimator lens 61 are further described.

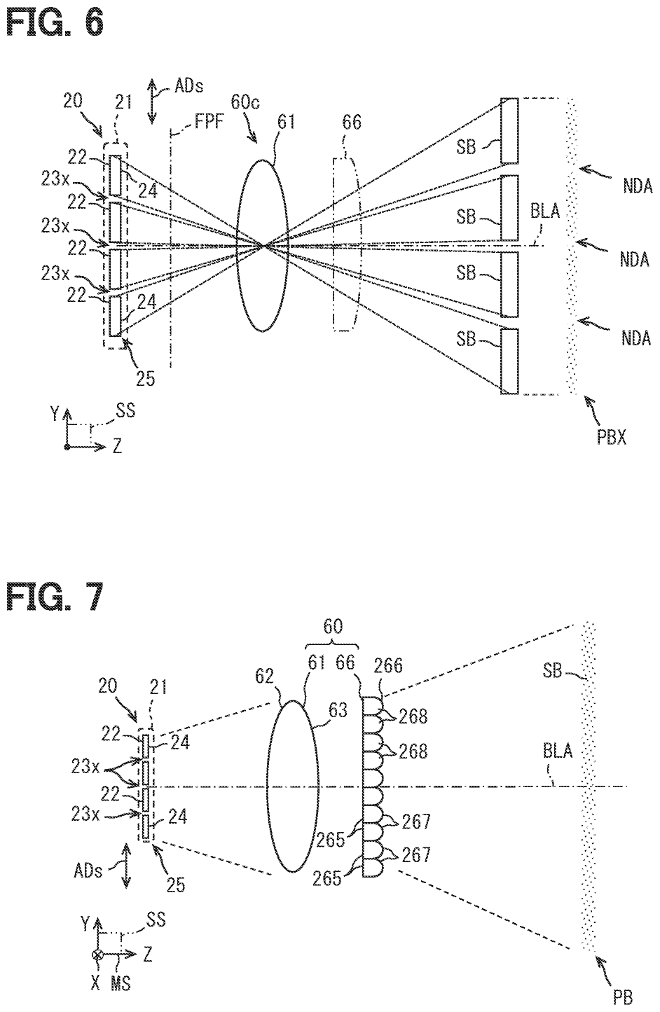

In an optical unit 60c of a comparative example shown in FIG. 6, the beam shaping lens 66 is omitted. Therefore, the beam SB transmitted through the collimator lens 61 is not spread in the light source array direction ADs. Therefore, the no-emitters 23x generated between the laser emission windows 24 in the light-emitting area 21 remain respectively as a gap between the respective beams SB in the projection beam PB. According to the above, the projection beam PB made up of a plurality of beams SB is divided into a plurality of discontinuous lines along the light source array direction ADs. A gap generated between the beams SB becomes a no-detection area NDA where an object cannot be detected.

On the other hand, in the optical unit 60 shown in FIG. 2, the composite focal plane FPF on the incident side by the collimator lens 61 and the cylindrical lens 166 is closer to the collimator lens 61 (i.e., in Z direction) than the light-emitting area 21 on the sub-scanning plane SS (i.e., Y-Z plane). That is, the light-emitting area 21 is provided at a position farther from the optical unit 60 than the composite focal plane FPF. Therefore, on the sub-scanning plane SS, the collimator lens 61 and the cylindrical lens 166 exert an optical effect of defocusing the laser emission opening 25 and extending the belt-like beam SB along the Y-axis. As a result, even when there are no-emitters 23x between the plurality of laser emission windows 24, the beams SB transmitted through the optical unit 60 overlap with each other to eliminate the no-detection area NDA. As described above, the projection beam PB composed of the plurality of beams SB has a line shape continuously extending along the light source array direction ADs.

On the other hand, on the main scanning plane MS (i.e., Z-X plane) shown in FIG. 3, the composite focal plane FPF by the collimator lens 61 and the cylindrical lens 166 intersects with the light-emitting area 21. In other words, the light-emitting area 21 is defined at a distance from the optical unit 60 in accordance with the position of the composite focal plane FPF. It should be noted that each of the laser emission windows 24 arranged in the light-emitting area 21 may be positioned slightly displaced from the composite focal plane FPF. Specifically, each of the laser emission windows 24 may be slightly offset in the Z direction with respect to the composite focal plane FPF, or may be slightly offset in the −Z direction (i.e., minus Z direction) with respect to the composite focal plane FPF.

According to the arrangement described above, since the cylindrical lens 166 does not have a positive power on the main scanning plane MS, the beam SB collimated by the collimator lens 61 travels along the beam light axis BLA, and passes through the cylindrical lens 166 substantially as it is. As a result, the collimator lens 61 and the cylindrical lens 166 can suppress the spread of the width of the belt-like beam SB, and can form a line-shaped projection beam PB maintaining a narrow beam width.

According to the first embodiment described above, the traveling direction of each beam SB emitted respectively from the plurality of laser oscillation elements 22 arranged in the specific light source array direction ADs is adjusted by the collimator lens 61. Further, each beam SB is spread along the light source array direction ADs on the sub-scanning plane SS by the positive power of the beam shaping lens 66. Therefore, even when the no-emitters 23x exist between the plurality of laser oscillation elements 22 in the light-emitting unit 20, the configuration described above makes it harder to generate a gap between the beams SB, which would otherwise cause a no-detection area NDA between the beams SB when projected to the measurement area. Therefore, it is possible to increase the resolution of detection of the LiDAR device 100.

In addition, in the first embodiment, the composite focal plane FPF formed by the collimator lens 61 and the beam shaping lens 66 is positioned closer to the collimator lens 61 than the laser oscillation element 22 on the sub-scanning plane SS. According to the positional relationship between the composite focal plane FPF and the laser oscillation elements 22, each of the beams SB respectively emitted from the laser oscillation elements 22 receives a positive power of the beam shaping lens 66 by passing through the optical unit 60, forming a continuous line shape with no gaps. As a result, the no-detection area NDA is substantially eliminated from the projection beam PB projected to the measurement area, thereby realizing the high-resolution LiDAR device 100 more reliably.

Further, in the first embodiment, the plurality of laser oscillation elements 22 are arranged in the light-emitting area 21 having a longitudinal shape whose longitudinal direction is the light source array direction ADs. In such a configuration, the projection beam PB obtained by superimposing or overlapping the beams SB transmitted through the optical unit 60 is formed into a continuous line shape by the optical action of the beam shaping lens 66, and is formed in a narrow and extending shape along the light source array direction ADs. As a result, the resolution in the direction along the sub-scanning plane SS is easily ensurable.

Furthermore, in the first embodiment, the light-emitting area 21 is put at a position of the composite focal plane FPF formed by the collimator lens 61 and the beam shaping lens 66 on the main scanning plane MS, which is orthogonal to the sub-scanning plane SS and which expands along the Z direction, i.e., along the transmission direction of the beam SB. In such manner, when the light-emitting area 21 where the laser oscillation elements 22 are arranged is defined at the position of the composite focal plane FPF, the spread of the beam on the main scanning plane MS is suppressed. As a result, the spread of the projection beam PB projected to the measurement area is suppressed, thereby less likely causing a deterioration of the resolution of detection even when the beam shaping lens 66 is added to the optical path.

In addition, the optical unit 60 of the first embodiment has the field throttle 73 positioned before the collimator lens 61. The field throttle 73 forms the incident-side opening 74 elongated in the longitudinal direction that is the light source array direction ADs. With the incident-side opening 74 having such a shape formed in the field throttle 73, the incidence of a stray light of the beam SB, which has been caused by a package of the laser oscillation element 22, the cover glass 27, and the like, into the collimator lens 61 can be effectively suppressed. Therefore, reduction of noise otherwise caused in the projection beam PB is realized.

Also, the optical unit 60 of the first embodiment has the opening throttle 78 positioned behind the beam shaping lens 66. The opening throttle 78 forms the emission-side opening 79 elongated in the longitudinal direction that is along the X-axis that is orthogonal to both of the light source array direction ADs and the Z direction. The emission-side opening 79 having such a shape can suppress the emission of the stray light generated by the lenses 61, 66, and the like on the sub-scanning plane SS, while transmitting the beam SB that is in parallel with the beam light axis BLA on the main scanning plane MS. As a result, noise reduction in the projection beam PB is realized.

In addition, the scanning unit 30 of the first embodiment has the scanning mirror 33 that rotates about the rotation axis AS along the light source array direction ADs. Thus, when the light source array direction ADs and the rotation axis AS are substantially in parallel with each other, scanning of the measurement area using a continuous line beam as the projection beam PB is realized. Therefore, the effect of increasing the resolution of the LiDAR device 100 is more likely exhibited.

Furthermore, in the first embodiment, the optical unit 60 includes, as a beam shaping lens 66, the cylindrical lens 166 having the cylindrical emission surface 167 convexly curved toward the emission side on the sub-scanning plane SS. Use of the cylindrical lens 166 makes it possible to exhibit a positive power only on the sub-scanning plane SS. As a result, (a) the optical action on the sub-scanning plane SS for spreading the beam SB and (b) the optical action on the main scanning plane MS for forming an image of the beam SB are easily and compatibly realized. As a result, it becomes easier to realize a high-resolution light detection device.

In addition, in the first embodiment, the cylindrical lens 166 having the same type of positive power is arranged behind the collimator lens 61 having the positive power. Such an arrangement enables reduction of the curvature of the cylindrical emission surface 167. Therefore, it becomes easy to ensure both of the manufacturability and the shape/dimension accuracy of the cylindrical lens 166.

Further, in the scanning unit 30 of the first embodiment, the reflecting surface 36 is formed on one side of the body portion 35 of the scanning mirror 33, and the scanning with the projection beam PB is performed as an oscillating or swinging motion (i.e., as a reciprocally-rotary motion of the scanning mirror 33). As a comparative example, assuming a configuration in which (i) both sides of the scanning mirror 33 are used as reflecting surfaces and (ii) the scanning mirror 33 is simply rotated, a no-detection period needs to be made during which projection of the projection beam PB is interrupted, for preventing the projection beam PB from being projected on an edge of the reflecting surface 36. On the other hand, when the scanning mirror 33 is reciprocally rotated, the no-detection period described above does not substantially occur. Therefore, scanning by reciprocally rotating the scanning mirror 33 is advantageous for increasing the resolution of the LiDAR device 100.

In the first embodiment, the laser oscillation element 22 corresponds to a “light emitter,” the scanning mirror 33 corresponds to a “rotary mirror,” the collimator lens 61 corresponds to a “first optical element,” and the beam shaping lens 66 corresponds to a “second optical element.” Further, the field throttle 73 corresponds to a “front diaphragm,” the incident-side opening 74 corresponds to a “front aperture,” the opening throttle 78 corresponds to a “rear diaphragm,” and the emission-side opening 79 corresponds to a “rear aperture,” and the cylindrical emission surface 167 corresponds to an “emission surface.” Furthermore, the light source array direction ADs corresponds to a “specific array direction,” the main scanning plane MS corresponds to an “orthogonal section,” the sub-scanning plane SS corresponds to a “specific section,” and the Z direction corresponds to a “(beam SB's) transmission direction.” Furthermore, the reflected beam RB corresponds to a “return light,” and the LiDAR device 100 corresponds to a “light detection device.”

### Second Embodiment

FIG. 7 illustrates the second embodiment of the present disclosure, which is a modification of the first embodiment. A lenticular lens 266 is adopted as the beam shaping lens 66 in the optical unit 60 of the second embodiment. Similarly to the collimator lens 61, the lenticular lens 266 is made of translucent material such as synthetic quartz glass, synthetic resin or the like. The lenticular lens 266 includes a large number of minute plano-convex lens portions 268. The lenticular lens 266 is an optical element in which a large number of plano-convex lens portions 268 are continuously arranged.

Each of the plano-convex lens portions 268 expands linearly along the X-axis. Each of the plano-convex lens portions 268 is arranged continuously along the light source array direction ADs (Y-axis). Each of the plano-convex lens portions 268 has a micro-incident surface 265 and a micro-emission surface 267, respectively. The micro-incident surface 265 is formed as a smooth plane. The micro-incident surfaces 265 of the plurality of plano-convex lens portions 268 are arranged continuously without steps along the light source array direction ADs, and form an incident surface of the lenticular lens 266. The lenticular lens 266 is arranged with the incident surface orthogonal to the beam light axis BLA. The micro-emission surface 267 is a spherical or aspherical partially-cylindrical surface, and has a shape convexly curved in the Z direction, which is the emission side on the sub-scanning plane SS. A plurality of micro-emission surfaces 267 form an emission surface of the lenticular lens 266 by continuously lining up along the light source array direction ADs.

The lenticular lens 266 has a positive power on the sub-scanning plane SS. The lenticular lens 266 spreads the beam SB substantially only in one direction on the sub-scanning plane SS by the optical action of refracting the beam SB by each of the micro-incident surfaces 265 and each of the micro-emission surfaces 267, thereby forming a projection beam PB in a continuous line shape. However, the lenticular lens 266 does not substantially exhibit the optical action of spreading the beam SB on the main scanning plane MS.

The second embodiment described above has the same effects as the first embodiment, and, even when the no-emitters 23x exist between the laser oscillation elements 22 arranged in the light-emitting area 21, the projection beam PB which is composed of a plurality of beams SB has a continuous line shape. Therefore, detection with high resolution is realized.

In addition, by adopting the lenticular lens 266 as in the second embodiment, it is possible to exhibit a positive power limited only on the sub-scanning plane SS. As a result, the optical action for expanding the beam SB on the sub-scanning plane SS and the optical action for forming an image of the beam SB on the main scanning plane MS are compatibly exerted with ease.

Furthermore, even when a relative position of the lenticular lens 266 with respect to the collimator lens 61 is shifted along the X-Y plane, the optical action on the beam SB is unlikely to change. Therefore, use of the lenticular lens 266 as the beam shaping lens 66 makes a positional deviation/shift of the lenticular lens 266 easily tolerable. In the second embodiment, the micro-emission surface 267 corresponds to an “emission surface.”

### Third Embodiment

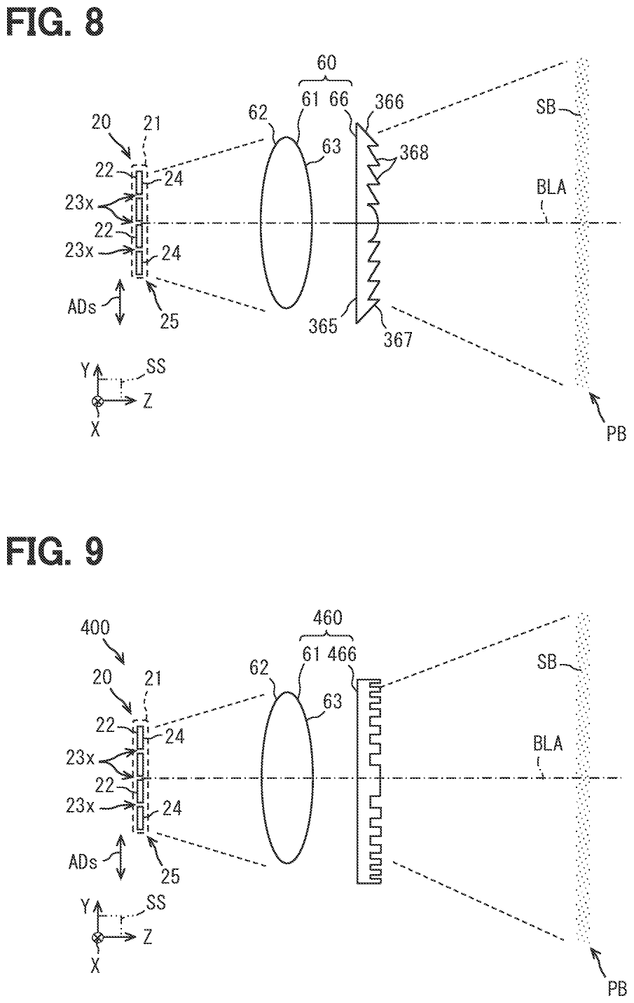

The third embodiment of the present disclosure, shown in FIG. 8, is another modification of the first embodiment. A Fresnel lens 366 is adopted as the beam shaping lens 66 in the optical unit 60 of the third embodiment. Similarly to the collimator lens 61, the Fresnel lens 366 is made of translucent material such as synthetic quartz glass, synthetic resin or the like. The Fresnel lens 366 has a Fresnel incident surface 365 and Fresnel emission surfaces 367.

The Fresnel incident surface 365 is a smooth plane, and substantially orthogonal to the beam light axis BLA. On the Fresnel emission surface 367, a plurality of divided emission surface portions 368 are arranged that are convexly curved toward the emission side on the sub-scanning plane SS as a whole. The divided emission surface portions 368 have a shape expanding along the X-axis, and are intermittently arranged along the light source array direction ADs.

The Fresnel lens 366 is arranged on an optical path of the beam SB so that the beam light axis BLA passes through the optical centers of the Fresnel incident surface 365 and the Fresnel emission surface 367. The normal to the optical center of the Fresnel incident surface 365 and the Fresnel emission surface 367, that is, the lens optical axis of the Fresnel lens 366 substantially coincides with the beam light axis BLA.

The third embodiment described above has the same effects as the first embodiment, and, even when the no-emitters 23x exist between the laser oscillation elements 22 arranged in the light-emitting area 21, the projection beam PB can have a continuous line shape. Therefore, detection with high resolution is realized. In addition, by adopting the Fresnel lens 366 as shown in the third embodiment, the thickness of the beam shaping lens 66 can be reduced. Therefore, the optical unit 60 can be made compact.

### Fourth Embodiment

The fourth embodiment of the present disclosure, shown in FIG. 9, is yet another modification of the first embodiment. An optical unit 460 of the fourth embodiment includes a diffractive optical element 466 as an optical element, instead of having the beam shaping lens 66 (see FIG. 2). The diffractive optical element 466 is formed in a plate shape as a whole. The diffractive optical element 466 is arranged behind the collimator lens 61 with both sides aligned with the X-Y plane. The diffractive optical element 466 exerts an optical action of spatially branching the transmitted beam SB and generates a diffracted light on the sub-scanning plane SS.

In the fourth embodiment described above, each of the beams SB whose traveling direction has been adjusted by the collimator lens 61 is spread on the sub-scanning plane SS along the light source array direction ADs, by the optical action of generating the diffracted light by the diffractive optical element 466. Therefore, even when the no-emitters 23x exist between the plurality of laser oscillation elements 22 in the light-emitting unit 20, the configuration described above makes it harder to generate a gap, which causes a no-detection area NDA between the beams SB when the beams SB are projected to the measurement area. Therefore, it is possible to increase the resolution of detection by the LiDAR device 400.

In addition, in the fourth embodiment, even when the relative position of the diffractive optical element 466 with respect to the light-emitting unit 20 is shifted along the X-Y plane, the optical action on the beam SB hardly changes. Therefore, a positional deviation/shift of the diffractive optical element 466 on the X-Y plane is easily tolerable. In addition, in the fourth embodiment, the diffractive optical element 466 corresponds to a “second optical element,” and the LiDAR device 400 corresponds to a “light detection device.”

### Fifth Embodiment

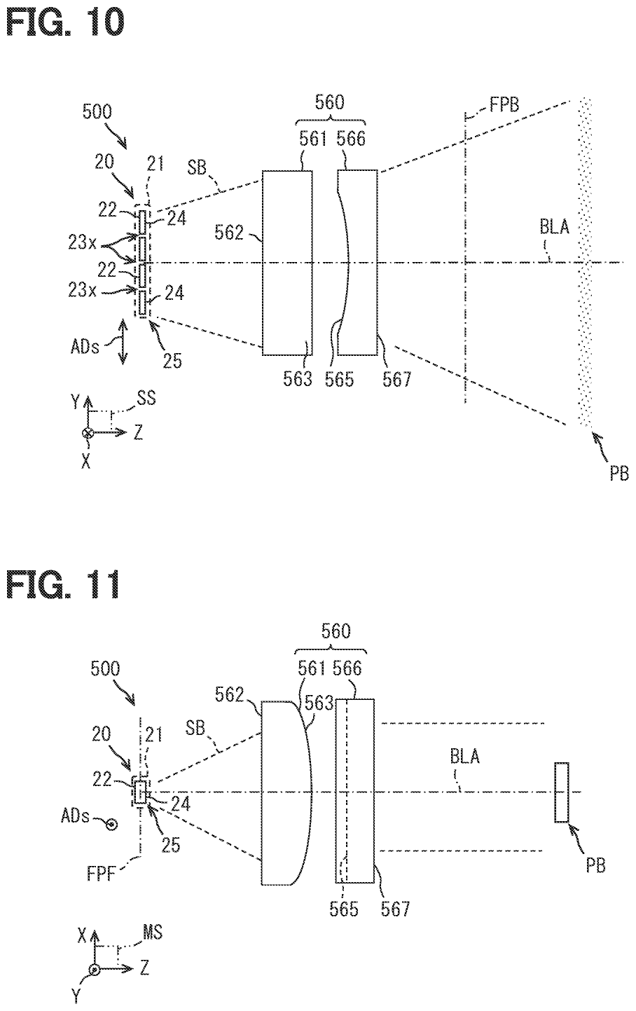

The fifth embodiment of the present disclosure, shown in FIGS. 10 and 11, is still yet another modification of the first embodiment. An optical unit 560 of the fifth embodiment is composed of optical elements such as a first cylindrical lens 561 and a second cylindrical lens 566.

The first cylindrical lens 561 is a plano-convex cylindrical lens made of translucent material such as synthetic quartz glass, synthetic resin or the like. A planar incident surface 562 and a convex cylindrical emission surface 563 are formed on the first cylindrical lens 561. The planar incident surface 562 is a smooth plane, and substantially orthogonal to the beam light axis BLA. The convex cylindrical emission surface 563 is a spherical, partially-cylindrical surface or an aspherical, partially-cylindrical surface, and has a shape convexly curved in the Z direction, which is the emission side, on the main scanning plane MS. The convex cylindrical emission surface 563 has a positive power in the transmission direction (i.e., Z direction) of the beam SB.

The first cylindrical lens 561 is arranged on the optical path of the beam SB so that the beam light axis BLA passes through the respective optical centers of the planar incident surface 562 and the convex cylindrical emission surface 563. The first cylindrical lens 561 is arranged on the beam light axis BLA in a posture in which the generatrix direction (i.e., no-power direction) of the convex cylindrical emission surface 563 is along the light source array direction ADs. The first cylindrical lens 561 exerts an optical action of refracting each of the beams SB on the main scanning plane MS, and functions as a collimator that generates parallel light(s) along the beam light axis BLA.

The second cylindrical lens 566 is a plano-concave cylindrical lens made of translucent material such as synthetic quartz glass, synthetic resin or the like. The second cylindrical lens 566 is positioned behind the first cylindrical lens 561 and is separated away from the first cylindrical lens 561. A concave cylindrical incident surface 565 and a planar emission surface 567 are formed on the second cylindrical lens 566. The concave cylindrical incident surface 565 is a spherical, partially-cylindrical surface or an aspherical, partially-cylindrical surface, and has a concavely curved shape toward the incident side on the sub-scanning plane SS. The concave cylindrical incidence surface 565 has a negative power in the transmission direction (i.e., Z direction) of the beam SB. The planar emission surface 567 is a smooth plane, and substantially orthogonal to the beam light axis BLA.

The second cylindrical lens 566 is arranged on the optical path of the beam SB so that the beam light axis BLA passes through the optical centers of the concave cylindrical incident surface 565 and the planar emission surface 567. The second cylindrical lens 566 is arranged on the beam light axis BLA in such a posture that the direction (i.e., power direction) orthogonal to the generatrix of the concave cylindrical incident surface 565 is along the light source array direction ADs. The second cylindrical lens 566 exerts an optical action of refracting each of the beams SB on the sub-scanning plane SS, and forms a projection beam PB in a line shape by extending each of the beams SB along the light source array direction ADs.

In the optical unit 560 described above, a composite focal plane (i.e., slow-axis focal plane) FPB by the first cylindrical lens 561 and the second cylindrical lens 566 on the sub-scanning plane SS (i.e., Y-Z plane) is defined on an emission side (i.e., Z direction) of the second cylindrical lens 566. On the other hand, the composite focal plane (i.e., fast-axis focal plane) FPF of the cylindrical lenses 561 and 566 on the main scanning plane MS (ZX plane) is defined on an incident side (−Z direction) of the first cylindrical lens 561, and overlaps with the light-emitting area 21.

Also, in the first cylindrical lens 561 and the second cylindrical lens 566, the convex cylindrical emission surface 563 and the concave cylindrical incident surface 565 may be spherically or aspherically formed. In addition, the first cylindrical lens 561 may be a plano-convex cylindrical lens having a cylindrical lens surface convexly curved on the incident side. Similarly, the second cylindrical lens 566 may be a plano-concave cylindrical lens having a cylindrical lens surface concavely curved on the emission side. Furthermore, the first cylindrical lens 561 and the second cylindrical lens 566 may both be cylindrical lenses having curvatures on both of the incident surface and the emission surface.

A LiDAR device 500 of the fifth embodiment described above also has the same effects as the first embodiment, and each of the beams SB emitted from a plurality of laser oscillation elements 22 that are arranged along the specific light source array direction ADs has its traveling direction adjusted by the convex cylindrical emission surface 563. Further, each of the beams SB is spread along the light source array direction ADs on the sub-scanning plane SS due to a negative power of the concave cylindrical incident surface 565. Therefore, even when the no-emitters 23x exist between the plurality of laser oscillation elements 22 in the light-emitting unit 20, a gap causing a no-detection area between the beams SB projected to the measurement area is less likely to occur. Therefore, it is possible to increase the resolution of detection of the LiDAR device 500.

In the fifth embodiment, the first cylindrical lens 561 corresponds to a “first optical element,” the convex cylindrical emission surface 563 corresponds to a “first cylindrical lens surface,” and the concave cylindrical incident surface 565 corresponds to a “second optical element.” Further, the second cylindrical lens 566 corresponds to a “second optical element,” and the LiDAR device 500 corresponds to a “light detection device.”

### Sixth Embodiment

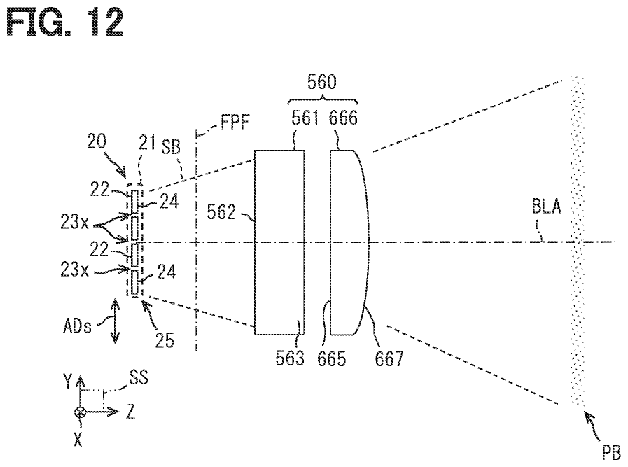

The sixth embodiment of the present disclosure, shown in FIG. 12, is a modification of the fifth embodiment. The optical unit 560 of the sixth embodiment is composed of optical elements such as the first cylindrical lens 561 and a second cylindrical lens 666.

The second cylindrical lens 666 is a plano-convex cylindrical lens made of translucent material such as synthetic quartz glass, synthetic resin or the like. The second cylindrical lens 666 is an optical element corresponding to the concave cylindrical incident surface 565 (see FIG. 10) of the fifth embodiment, and is positioned behind the first cylindrical lens 561. A planar incident surface 665 and a convex cylindrical emission surface 667 are formed on the second cylindrical lens 666. The planar incident surfaced 665 is a smooth plane, and substantially orthogonal to the beam light axis BLA. The convex cylindrical emission surface 667 is a spherical, partially-cylindrical surface or an aspherical, partially-cylindrical surface, and has a shape convexly curved toward the emission side on the sub-scanning plane SS. The convex cylindrical emission surface 667 may be formed in a spherical shape or may be formed in an aspherical shape. The convex cylindrical emission surface 667 has a positive power in the transmission direction (i.e., Z direction) of the beam SB.

The second cylindrical lens 666 is arranged on the optical path of the beam SB so that the beam light axis BLA passes through the respective optical centers of the planar incident surface 665 and the convex cylindrical emission surface 667. The second cylindrical lens 666 is arranged on the beam light axis BLA in such a posture that the direction (i.e., a power direction) orthogonal to the generatrix of the convex cylindrical emission surface 667 is along the light source array direction ADs. The second cylindrical lens 666 exerts an optical action of refracting each of the beams SB on the sub-scanning plane SS, and forms the projection beam PB in a line shape by extending each of the beams SB in the light source array direction ADs.

According to the optical configuration described above, the composite focal plane (i.e., a slow-axis focal plane) FPF of the first cylindrical lens 561 and the second cylindrical lens 666 is defined on the incident side (−Z direction) of the first cylindrical lens 561. The light-emitting area 21 is positioned farther from the first cylindrical lens 561 than the composite focal plane FPF.

In the sixth embodiment described above, the same effects as in the fifth embodiment are obtained, thereby resolution of detection can be improved by forming a continuous line-shaped projection beam PB. In the sixth embodiment, the convex cylindrical emission surface 667 corresponds to a “second cylindrical lens surface,” and the second cylindrical lens 666 corresponds to a “second optical element.”

### Seventh Embodiment

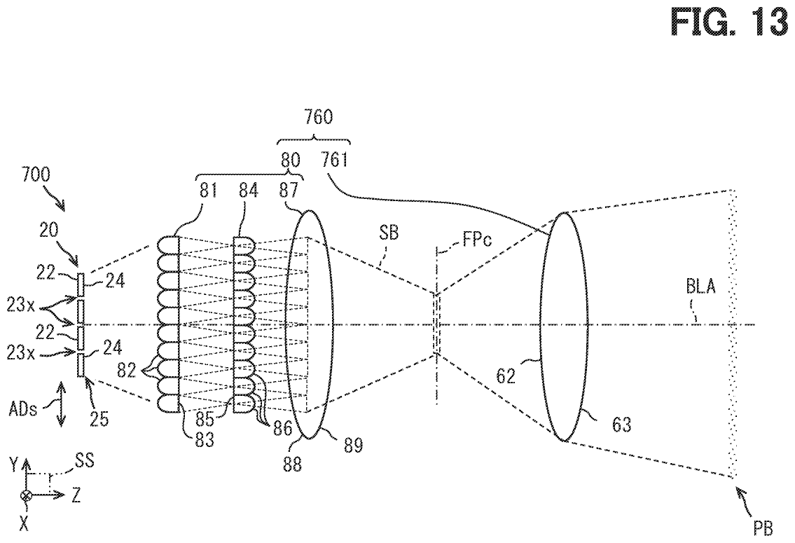

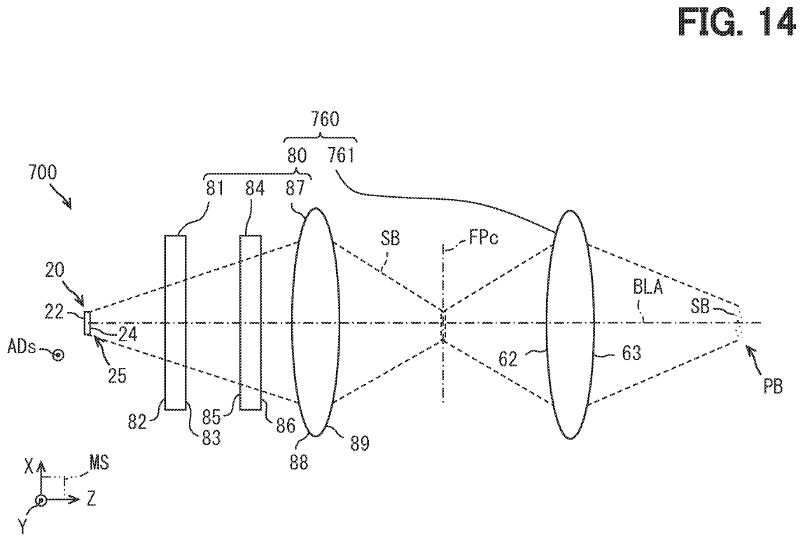

The seventh embodiment of the present disclosure, shown in FIGS. 13 and 14, is still yet another modification of the first embodiment. An optical unit 760 of the seventh embodiment has a configuration including a homogenizer 80, a collimator lens 761, and the like.

The homogenizer 80 is positioned between the light-emitting unit 20 and the collimator lens 761, and exhibits a function of equalizing the intensity of each of the beams SB emitted from the plurality of laser oscillation elements 22 at least along the light source array direction ADs. The homogenizer 80 includes optical elements such as a first lenticular lens 81, a second lenticular lens 84, a lens 87 having a positive power, and the like. Each of the optical elements constituting the homogenizer 80 may have a spherical lens surface or an aspherical lens surface.

The first lenticular lens 81 and the second lenticular lens 84 are optical elements substantially identical to each other, and are optical elements formed by continuously arranging a large number of plano-convex lens portions. The first lenticular lens 81 and the second lenticular lens 84 are arranged before the lens 87 having a positive power, and their planar lens surfaces face each other.

The first lenticular lens 81 has a large number of convex incident surface portions 82 and a planar emission surface 83. The convex incident surface portion 82 is formed in a partially cylindrical shape, and is convexly curved toward the incident side on the sub-scanning plane SS. Each of the convex incident surface portions 82, which is arranged in a posture in which the power direction orthogonal to the generatrix is along the light source array direction ADs, forms the incident surface of the first lenticular lens 81. The convex incident surface portion 82 has a positive power, and refracts each of the beams SB incident from each of the laser oscillation elements 22 in a condensing direction. The planar emission surface 83 is a smooth plane, and transmits the beam SB refracted by each of the convex incident surface portions 82.

The second lenticular lens 84 is arranged behind the first lenticular lens 81. The second lenticular lens 84 has a planar incident surface 85 and a number of convex emission surface portions 86. The planar incident surface 85 is a smooth plane, and is arranged to face the planar emission surface 83 at a position away from the first convex lens array 181. The convex emission surface portion 86 is formed in substantially the same partial cylindrical shape as the convex incident surface portion 82, and is convexly curved toward the emission side on the sub-scanning plane SS. Each of the convex emission surface portions 86 is arranged continuously along the light source array direction ADs, with the power direction orthogonal to the generatrix being aligned with the light source array direction ADs, to form the emission surface of the second lenticular lens 84. The position of each of the convex emission surface portions 86 on the X-Y plane is substantially aligned with the position of each of the convex incident surface portions 82. The convex emission surface portion 86 has a positive power, and further refracts each of the beams SB incident on the planar incident surface 85 in a condensing direction.

The lens 87 having a positive power is arranged behind the second lenticular lens 84. The lens 87 having a positive power has, for example, a convex incident surface 88 and a convex emission surface 89. The lens 87 having a positive power exhibits a positive power both on the main scanning plane MS and on the sub-scanning plane SS. The lens 87 having a positive power forms, behind the homogenizer 80, an intermediate image of the beams SB in a line shape whose intensity is made equal along the light source array direction ADs.

The collimator lens 761 is an aspherical lens having a positive power, is substantially the same as the collimator lens 61 (see FIG. 1) of the first embodiment, and has, for example, the convex incident surface 62 and the convex emission surface 63. The collimator lens 761 is positioned behind the homogenizer 80. The collimator lens 761 converts the beams SB transmitted through the homogenizer 80 into parallel lights along the beam light axis BLA. A focal plane FPc on the incident side of the collimator lens 761 is defined at a position where the homogenizer 80 forms an intermediate image of the beams SB. In other words, the collimator lens 761 is provided at a position separated by the focal length from an imaging position where the beams SB are intermediately imaged. The collimator lens 761 shapes the beams SB intermediately imaged by the homogenizer 80 to form a linearly expanding projection beam PB.

A LiDAR device 700 of the seventh embodiment described above also has the same effects as the first embodiment, in which the beams SB emitted from each of the plurality of laser oscillation elements 22 arranged along a specific light source array direction ADs have equal intensity in the light source array direction ADs. Further, each of the beams SB is shaped into a line expanding along the light source array direction ADs by the collimator lens 761. Therefore, even when the no-emitters 23x exist between the plurality of laser oscillation elements 22 in the light-emitting unit 20, a gap causing a no-detection area between the beams SB projected to the measurement area is less likely to occur. Therefore, it is possible to increase the resolution of detection of the LiDAR device 700.

In addition, in a configuration of the seventh embodiment using a pair of lenticular lenses 81 and 84 as the homogenizer 80, the intensity of the beams SB can be effectively made equal. As a result, in addition to disappearance of the no-detection area, the projection beam PB whose intensity is made equal as a whole is projectable. Therefore, the resolution of detection of the LiDAR device 700 can be further improved.

In the seventh embodiment, the convex incident surface portion 82 corresponds to a “first emission surface,” the convex emission surface portion 86 corresponds to a “second emission surface,” and the collimator lens 761 corresponds to a “shaping optical element,” and the LiDAR device 700 corresponds to a “light detection device.”

### Eighth Embodiment

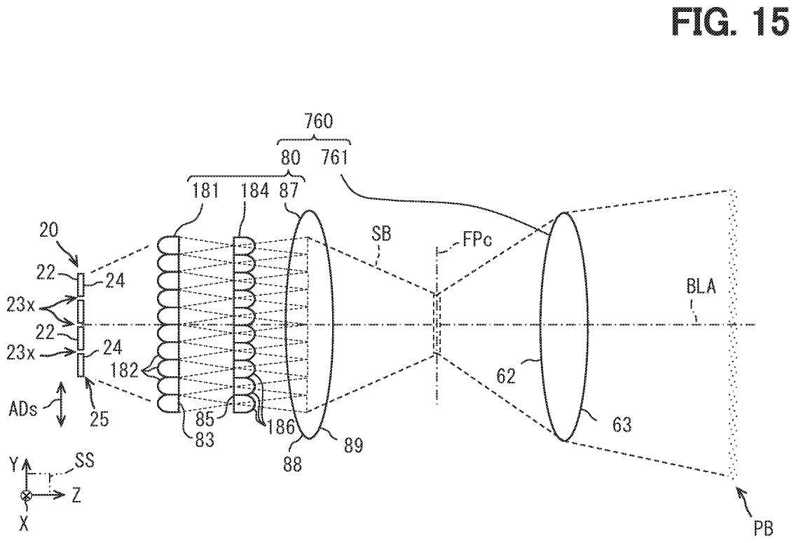

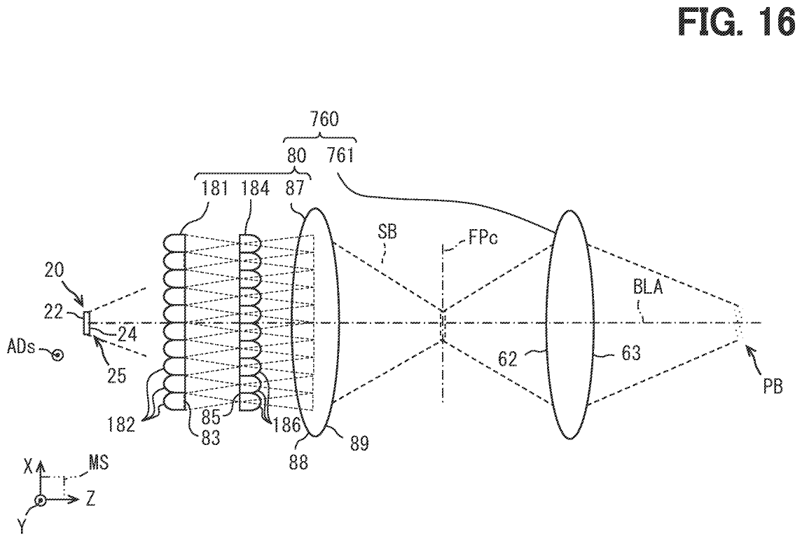

The eighth embodiment of the present disclosure, shown in FIGS. 15 and 16, is a modification of the seventh embodiment. The homogenizer 80 of the eighth embodiment has, together with the lens 87 having a positive power, a first convex lens array 181 and a second convex lens array 184 instead of having the first lenticular lens 81 and the second lenticular lens 84. The first convex lens array 181 and the second convex lens array 184 are optical elements that are substantially the same with each other, and are optical elements formed by continuously two-dimensionally arranging a large number of micro-lens portions. The first convex lens array 181 and the second convex lens array 184 are arranged before the lens 87 having a positive power with their planar lens surfaces facing each other.

The first convex lens array 181 has a large number of convex incident surface portions 182 and the planar emission surface 83. The convex incident surface portion 182 is formed in a convex spherical shape and is convexly curved toward the incident side. Each of the convex incident surface portions 82 is continuously two-dimensionally arranged along the X-Y plane (i.e., along the planar emission surface 83) to form the incident surface of the first convex lens array 181. The convex incident surface portion 182 has a positive power, and refracts each of the beams SB incident from each of the laser oscillation elements 22 in a condensing direction in both of the main scanning plane MS and the sub-scanning plane SS. The planar emission surface 83 is a smooth plane, and transmits the beams SB refracted by each of the convex incident surface portions 82.

The second convex lens array 184 is arranged behind the first convex lens array 181. The second convex lens array 184 has the planar incident surface 85 and a large number of convex emission surface portions 186. The planar incident surface 85 is a smooth plane, and is arranged to face the planar emission surface 83 at a position away from the first convex lens array 181. The convex emission surface portion 186 is formed in a hemispherical shape substantially same as the convex incidence surface portion 182 and is convexly curved toward the emission side. Each of the convex emission surface portions 186 is continuously two-dimensionally arranged along the X-Y plane (i.e., along the planar incident surface 85) to form the emission surface of the second convex lens array 184. The position of each of the convex emission surface portions 186 on the X-Y plane substantially matches the position of each of the convex incident surface portions 182. The convex emission surface portion 186 has a positive power, and further refracts each of the beams SB incident on the planar incident surface 85 in a condensing direction in both of the main scanning plane MS and the sub-scanning plane SS.

Even in the eighth embodiment described above, the same effects as in the seventh embodiment can be obtained, and the homogenizer 80 can homogenize the intensity of the beam SB in the light source array direction ADs. As a result, the continuous line-shaped projection beam PB expanding along the light source array direction ADs is formed, thereby realizing high resolution detection.

In addition, a configuration by using a pair of convex lens arrays 181 and 184 as the homogenizer 80, as shown in the eighth embodiment, can effectively homogenize the intensity of the beam SB. As a result, not only diminishing the no-detection area, but also the projection beam PB having an equal intensity is projectable, thereby further improving the resolution of detection.

### Other Embodiments

Although a plurality of embodiments of the present disclosure have been described above, the present disclosure should not be construed as limited to the above embodiments, but can also be applied to various embodiments and combinations without departing from the gist thereof.

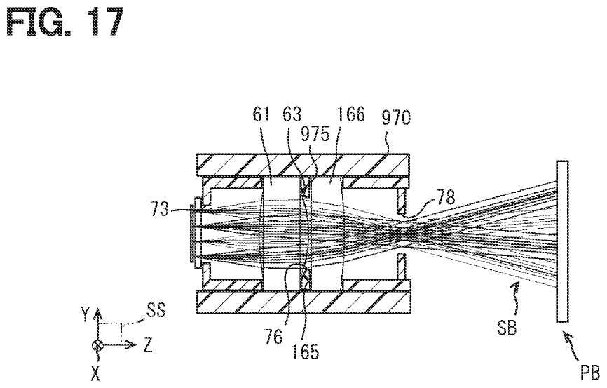

In addition to the field throttle 73 and the opening throttle 78, an intermediate throttle 76 is provided in a lens barrel 970 in Modification 1 of the above embodiment shown in FIG. 17. The intermediate throttle 76 is a substantially rectangular opening formed in an intermediate member 975. The intermediate throttle 76 passes the beam SB traveling from the convex emission surface 63 to the planar incident surface 165. The intermediate throttle 76 suppresses the generation of stray light inside the lens barrel 970.

In the above embodiment, the scanning mirror 33 is provided in common for the projection beam PB and the reflected beam RB. The rotation axis AS of such scanning mirror 33 may be slightly inclined with respect to the Y-axis of the optical unit 60. Further, in Modification 2 of the above embodiment, a scanning mirror for deflecting the reflected beam RB is provided separately from the scanning mirror for deflecting the projection beam PB. In addition, the scanning mirror for deflecting the projection beam SB is omitted in Modification 3 of the above embodiment. In Modification 3, a plurality of laser emission openings 25 are arranged along the X-axis, and, in the light emission control unit 51, each of the laser emission openings 25 sequentially emits the beam SB. Further, in Modification 4 of the above embodiment, the scanning mirror that deflects the reflected beam RB is further omitted. In Modification 4, a detector having a planar detection surface detects the reflected beam RB in the light-receiving unit.

In Modification 5 of the above-described embodiment, the scanning mirror does not reciprocally-rotate in the predetermined angular range RA, but rotates 360 degrees in one direction. In the scanning mirror of Modification 5, reflecting surfaces are formed on both surfaces of the main body. The scanning mirror may be a mirror that performs two-dimensional scanning, such as a polygon mirror or the like.

In Modifications 6 and 7 of the above embodiments, the beam light axis BLA and the light-receiving optical axis RLA are not arranged in parallel. Specifically, in the Modification 6, the distance between the beam light axis BLA and the light-receiving optical axis RLA gradually decreases when a light approaches the reflecting surface 36 of the scanning mirror 33. On the other hand, in the Modification 7, the distance between the beam light axis BLA and the light-receiving optical axis RLA gradually increases when a light approaches the reflecting surface 36 of the scanning mirror 33.

The beam shaping lens 66 in Modification 8 of the above embodiment has not only a positive power on the sub-scanning plane SS but also on the main scanning plane MS. That is, the emission surface of the beam shaping lens 66 has a slight curvature even in a cross section along the main scanning plane MS. When the beam shaping lens 66 has a positive power on the sub-scanning plane SS as shown in Modification 8 described above, other optical characteristics may be changed as appropriate.

In Modification 9 of the above embodiment, an arithmetic processing unit corresponding to the controller 50 is provided outside the housing of the LiDAR device. The arithmetic processing unit may be provided as an independent in-vehicle ECU, or may be implemented as a functional unit in the drive support ECU or the automatic driving ECU. Further, in Modification 10 of the above embodiment, the function of the controller 50 is implemented as a functional section in the detector 41 of the light-receiving unit 40.

In Modification 11 of the above embodiment, a LiDAR device is mounted on a mobile object different from a vehicle. Specifically, the LiDAR device may be mounted on an unmanned and movable delivery robot, drone, or the like. Further, in Modification 12 of the above embodiment, the LiDAR device is attached to a non-movable object. The LiDAR device may be configured to measure target objects to be measured such as vehicles, pedestrians and the like as a built-in device incorporated in a road infrastructure such as a roadside device or the like, for example.

The processor and techniques described in the present disclosure may be implemented as a processing unit of a dedicated computer programmed to perform one or more functions embodied by a computer program. Alternatively, the processors and techniques described in the present disclosure may be implemented by dedicated hardware logic circuitry. Also, the processors and techniques described in the present disclosure may be implemented by discrete circuits. Alternatively, the processors and techniques described in the present disclosure may be implemented as any combination of components selected from among one or more computer processing units executing computer programs, one or more hardware logic circuits, and one or more discrete circuits. Further, the computer program may be stored in a computer-readable, non-transitory, tangible storage medium as computer-executable instructions.

What is claimed is:

1. A light detection device comprising:
a light-emitting unit including a plurality of light emitters spaced from each other, arranged along a specific array direction, and configured to emit a beam;
a scanning unit configured to scan the beam emitted from the light-emitting unit to project the beam to a measurement area;
a light-receiving unit configured to receive a return light of the beam from the measurement area; and
an optical unit positioned on an optical path of the beam directed from the light-emitting unit to the scanning unit, wherein
the optical unit includes:
a first optical element having a positive power in a transmission direction of the beam directed from the light-emitting unit to the scanning unit; and
a second optical element positioned behind the first optical element and having a positive power in the transmission direction of the beam in a specific section that expands along both of the transmission direction and the specific array direction, and
the optical unit includes, as the second optical element, a Fresnel lens including divided emission surface portions arranged intermittently and each of which is convexly curved toward an emission side in the specific section.

2. The light detection device according to claim 1, wherein
in the specific section, a position of a composite focal point on an incident side of the first optical element and the second optical element is closer to the first optical element than the light-emitting unit.

3. A light detection device comprising:
a light-emitting unit including a plurality of light emitters spaced from each other, arranged along a specific array direction, and configured to emit a beam;
a scanning unit configured to scan the beam emitted from the light-emitting unit to project the beam to a measurement area;
a light-receiving unit configured to receive a return light of the beam from the measurement area; and
an optical unit positioned on an optical path of the beam directed from the light-emitting unit to the scanning unit, wherein
the optical unit includes:
a first optical element having a positive power in a transmission direction of the beam directed from the light-emitting unit to the scanning unit; and
a second optical element positioned behind the first optical element and having a positive power in the transmission direction of the beam in a specific section that expands along both of the transmission direction and the specific array direction, and
a position of a composite focal point of the first optical element and the second optical element on an incident side in the specific section is closer to the first optical element than a position of a composite focal point of the first optical element and the second optical element on the incident side in an orthogonal section that is orthogonal to the specific section and along the transmission direction.

4. The light detection device according to claim 3, wherein
the optical unit includes, as the second optical element, a cylindrical lens having an emission surface convexly curved in the specific section toward an emission side.

5. The light detection device according to claim 3, wherein
the optical unit includes, as the second optical element, a lenticular lens including a plurality of emission surfaces arranged continuously and each of which is convexly curved toward an emission side in the specific section.

6. The light detection device according to claim 3, wherein
the optical unit includes, as the second optical element, a Fresnel lens including divided emission surface portions arranged intermittently and each of which is convexly curved toward an emission side in the specific section.

7. The light detection device according to claim 1, wherein
the plurality of light emitters are arranged in a longitudinal light-emitting area elongated in the specific array direction.

8. The light detection device according to claim 7, wherein
in an orthogonal section that is orthogonal to the specific section and along the transmission direction, the light-emitting area is at a composite focal point on an incident side of the first optical element and the second optical element.

9. The light detection device according to claim 1, wherein
the optical unit includes a front diaphragm before the first optical element, and
the front diaphragm forms a rectangular front aperture.

10. The light detection device according to claim 1, wherein
the optical unit includes a rear diaphragm behind the second optical element, and
the rear diaphragm forms a rectangular rear aperture.

11. The light detection device according to claim 1, wherein
the scanning unit has a rotary mirror rotatable about a rotation axis that is along the specific array direction.

12. A light detection device comprising:
a light-emitting unit including a plurality of light emitters spaced from each other, arranged along a specific array direction, and configured to emit a beam;
a scanning unit configured to scan the beam emitted from the light-emitting unit to project the beam to a measurement area;
a light-receiving unit configured to receive a return light of the beam from the measurement area; and
an optical unit positioned on an optical path of the beam directed from the light-emitting unit to the scanning unit, wherein
the optical unit includes:
a first optical element having a first cylindrical lens surface that has a positive power in a transmission direction of the beam directed from the light-emitting unit to the scanning unit, the first optical element arranged, such that a generatrix direction of the first cylindrical lens surface is along the specific array direction; and
a second optical element positioned behind the first optical element and having a second cylindrical lens surface that has a negative power in the transmission direction, the second optical element arranged, such that an orthogonal direction of a generatrix of the second cylindrical lens surface is along the specific array direction, and
a position of a composite focal point of the first optical element and the second optical element on an incident side in a specific section, which expands in the transmission direction and the specific array direction, is defined on an emission side of the second optical element.

13. A light detection device comprising:
a light-emitting unit including a plurality of light emitters spaced from each other, arranged along a specific array direction, and configured to emit a beam;
a scanning unit configured to scan the beam emitted from the light-emitting unit to project the beam to a measurement area;
a light-receiving unit configured to receive a return light of the beam from the measurement area; and
an optical unit positioned on an optical path of the beam directed from the light-emitting unit to the scanning unit, wherein
the optical unit includes:
a first optical element having a first cylindrical lens surface that has a positive power in a transmission direction of the beam directed from the light-emitting unit to the scanning unit, the first optical element arranged, such that a generatrix direction of the first cylindrical lens surface is along the specific array direction; and
a second optical element positioned behind the first optical element and having a second cylindrical lens surface that has a positive power in the transmission direction, the second optical element arranged, such that an orthogonal direction of a generatrix of the second cylindrical lens surface is along the specific array direction, and
a position of a composite focal point of the first optical element and the second optical element on an incident side in a specific section, which expands in the transmission direction and the specific array direction, is closer to the first optical element than a position of a composite focal point of the first optical element and the second optical element on the incident side in an orthogonal section that is orthogonal to the specific section and along the transmission direction.

14. A light detection device comprising:
a light-emitting unit including a plurality of light emitters spaced from each other, arranged along a specific array direction, and configured to emit a beam;
a scanning unit configured to scan the beam emitted from the light-emitting unit to project the beam to a measurement area;
a light-receiving unit configured to receive a return light of the beam from the measurement area; and
an optical unit positioned on an optical path of the beam directed from the light-emitting unit to the scanning unit, wherein
the optical unit includes:
a homogenizer configured to homogenize an intensity of beam emitted from each of the plurality of light emitters at least along the specific array direction; and
a shaping optical element positioned behind the homogenizer and configured to shape the beam, which is imaged by the homogenizer, in a line shape extending along the specific array direction.

15. The light detection device according to claim 14, wherein
the homogenizer includes:
a first lenticular lens including a plurality of first emission surfaces arranged continuously and each of which is convexly curved in a specific section that expands in both of a transmission direction of the beam and the specific array direction; and
a second lenticular lens positioned behind the first lenticular lens and including a plurality of second emission surfaces continuously arranged along the specific array direction and each of which is convexly curved in the specific section.

16. The light detection device according to claim 14, wherein
the homogenizer includes:
a first convex lens array including a plurality of convexly curved first emission surfaces arranged continuously and two-dimensionally; and
a second convex lens array positioned behind the first convex lens array and including a plurality of convexly curved second emission surfaces arranged continuously and two-dimensionally.
